(19) United States
(12) Patent Application Publication
(10) Pub. No.: US 2025/0299301 A1
(43) Pub. Date: Sep. 25, 2025

(54) ARTIFACT-REDUCTION IN MEDICAL IMAGES USING CONCATENATED RESIDUAL NETWORK

(71) Applicant: GE Precision Healthcare LLC, Waukesha, WI (US)

(72) Inventor: Xinzeng Wang, Houston, TX (US)

(21) Appl. No.: 18/609,986

(22) Filed: Mar. 19, 2024

(51) Int. Cl. G06T 5/60; G06T 5/50; G06T 5/70; G06T 7/00

(52) U.S. Cl. CPC G06T 5/60; G06T 5/50; G06T 5/70; G06T 7/0012; G06T 2207/10088; G06T 2207/20081; G06T 2207/20084; G06T 2207/20092; G06T 2207/20224; G06T 2207/30168

(57) ABSTRACT

The current disclosure provides methods and systems for increasing a performance of a residual neural network at reducing artifacts of various types in a medical image. The disclosed artifact-reducing network has a multi-stage architecture comprising a plurality of residual blocks that are organized into distinct stages that are concatenated, where each residual block may include a plurality of convolutional layers. The residual blocks and convolutional layers of each stage are configured and trained to detect and reduce different types of artifacts occurring at different scales in the medical image. Artifacts of a local scale may be removed first, by initial stages of the artifact-reducing neural network. Artifacts of a global scale may be removed by later stages of the artifact-reducing neural network.

### TECHNICAL FIELD

Embodiments of the subject matter disclosed herein relate to medical imaging, and more particularly, to systems and methods for removing artifacts from medical images.

### BACKGROUND

Medical images such as magnetic resonance (MR) images may include artifacts, which may reduce a quality of the images and hinder diagnosis. Various approaches have been taken to reduce or remove the artifacts. For example, a convolutional neural network (CNN) may be trained to reduce artifacts in MR images. The CNN may be trained on image pairs including a first input image having artifacts, and a second, target (ground truth) image not having artifacts. The CNN may learn to map the images with artifacts to the artifact-reduced images, and when trained, the CNN may output artifact-reduced versions of MR images inputted into the CNN. However, CNNs trained in this manner may not sufficiently reduce the artifacts, where some artifacts may remain in the images after being processed by the CNNs. In particular, a single CNN may have difficulty reducing artifacts of different scales, where a first CNN may effectively reduce local artifacts in an image, such as noise, but may not effectively reduce global artifacts, such as motion artifacts. A second CNN may effectively reduce the global artifacts, but may not effectively reduce the local artifacts.

### BRIEF DESCRIPTION

In one example, the above issues may be addressed via an image processing system, comprising a trained artifact estimation network including a plurality of stages, the artifact estimation network trained to estimate artifacts in a medical image; and a processor communicably coupled to a non-transitory memory storing the artifact estimation network, the memory including instructions that when executed, cause the processor to receive a medical image; generate an estimated artifact image from the medical image using the trained artifact estimation network; generate an artifact-reduced image by subtracting the estimated artifact image from the medical image, the artifact-reduced image a version of the medical image including a lesser amount of artifacts than the medical image; and display the artifact-reduced image on a display device; wherein each stage of the trained artifact estimation network estimates artifacts of a different scale in the medical image.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

Various aspects of this disclosure may be better understood upon reading the following detailed description and upon reference to the drawings in which:

FIG. 1 shows a block diagram of an MRI system according to one or more embodiments of the present disclosure;

FIG. 2 shows a block diagram of an exemplary embodiment of an image processing system, in accordance with one or more embodiments of the present disclosure;

FIG. 3 shows a block diagram of an exemplary embodiment of an artifact estimation network training system for training an artifact estimation network, in accordance with one or more embodiments of the present disclosure;

FIG. 4 shows a flowchart illustrating an exemplary method for training the artifact estimation network, in accordance with one or more embodiments of the present disclosure;

FIG. 5 shows a flowchart illustrating an exemplary method for deploying the trained artifact estimation network to reduce artifacts in medical images, in accordance with one or more embodiments of the present disclosure;

FIG. 6 shows an exemplary architecture of the artifact estimation network, in accordance with one or more embodiments of the present disclosure;

FIG. 7 shows an exemplary architecture of a first stage of the artifact estimation network, in accordance with one or more embodiments of the present disclosure;

FIG. 8 shows an exemplary architecture of a second stage of the artifact estimation network, in accordance with one or more embodiments of the present disclosure;

FIG. 9 shows a first exemplary output of the trained artifact estimation network, in accordance with one or more embodiments of the present disclosure;

FIG. 10 shows a second exemplary output of the trained artifact estimation network, in accordance with one or more embodiments of the present disclosure; and

FIG. 11 shows a exemplary outputs of different stages of the trained artifact estimation network, in accordance with one or more embodiments of the present disclosure.

The drawings illustrate specific aspects of the described systems and methods. Together with the following description, the drawings demonstrate and explain the structures, methods, and principles described herein. In the drawings, the size of components may be exaggerated or otherwise modified for clarity. Well-known structures, materials, or operations are not shown or described in detail to avoid obscuring aspects of the described components, systems and methods.

### DETAILED DESCRIPTION

Methods and systems are provided herein for reducing artifacts in medical image data, such as magnetic resonance (MR) images, computed tomography (CT) images, positron emission tomography (PET) images, or other types of medical images. Various approaches have been formulated to reduce or remove the artifacts. In particular, deep learning (DL) based methods have been developed for processing the medical images to reduce artifacts in the images. For example, a neural network may be trained to detect and extract noise and artifacts from a medical image. A medical image including artifacts may be inputted into a first neural network, and the first neural network may output an artifact-reduced image, where the artifact-reduced image is a version of the medical image with a reduced amount of noise and artifacts. Alternatively, in some examples, the medical image including artifacts may be inputted into a second neural network, and the second neural network may output extracted noise and artifact image data. The extracted noise and artifact image data may be subtracted from the medical image to generate the artifact-reduced image.

Various types of neural networks may be used to remove artifacts from images. The neural network may be a convolutional neural network (CNN), including a plurality of interconnected layers. At each subsequent layer of a CNN, more intricate and abstract features may be extracted, which may increase a performance of the CNN. However, as the number of layers of a CNN increase above a threshold, the performance and accuracy of the CNN may degrade, and the CNN may stop learning. For example, gradients of a loss function of the CNN may decrease in size as a number of layers of the CNN increases, where adjustments to parameters (e.g., weights) of the CNN during backpropagation may become increasingly negligible. In other cases, the gradients may become large, generating instability during the training.

To increase the performance and accuracy of a CNN including multiple layers, the layers may be grouped into blocks (e.g., residual blocks), and skip connections may be included in the CNN, whereby an input into a block is added as an additional output of the block (e.g., an identity mapping). The input added to the output bypasses the convolutional layers included in the block. The addition of the skip connections may increase an efficiency of gradient descent during backpropagation when the number of layers of the CNN exceeds the threshold. As a result, the depth of the CNN may be increased without a reduction in performance, and an accuracy of the output may be increased. Such architectures are typically referred to as residual networks. For example, residual networks may include 30 or more layers.

A conventional residual network may be used to remove artifacts from a medical image, such as an MR image. However, the medical image may include various types of artifacts. The artifacts may include both local features (e.g., noise, fine lines, ringing, etc.) and global features (motion, streaks, aliasing, etc.). Fine lines are often caused by stimulated echoes, and ringing is commonly seen around edges due to truncation in the frequency domain. Streaks are usually observed in images acquired with radial sampling pattern, while aliasing is often caused by unsuppressed signals out of prescribed field-of-view. A performance of the conventional residual network on a first type of artifact may be different from a performance of the conventional residual network on a second type of artifact. Training the conventional residual network to perform well on a variety of different artifact types may be difficult. Training the conventional residual network may rely on generating a large amount of training data including various types of artifacts in various combinations, which may be time consuming and difficult to obtain. Further, local and global artifacts may interact with each other, creating secondary features in the image domain. This additional complexity may make it harder for a conventional residual network to learn and separate different artifacts, resulting in inaccurate estimation and/or insufficient removal of these artifacts. As a result, the conventional residual network may remove one or more types of artifacts from a medical image, but leave other types of artifacts.

A plurality of conventional residual networks may be used in series to remove artifacts of different types. For example, a medical image may be inputted into a first conventional residual network, and the first conventional residual network may detect and reduce a first type of artifact. A second medical image outputted by the first conventional residual network with a reduced amount of the first type of artifact may be inputted into a second conventional residual network. The second conventional residual neural network may detect and reduce a second type of artifact. A third medical image outputted by the second conventional residual network with a reduced amount of the second type of artifact may be inputted into a third conventional residual network, and so on. By chaining conventional residual networks in this manner, the generation of training data sets may be simplified and a performance of each of the conventional residual networks may be individually increased.

However, the inventors herein have recognized a problem with chaining conventional residual networks in this manner, where the chained networks may not result in images that are artifact free or that have a significant reduction in a number or extent of the different types of artifacts. When the first conventional residual network reduces the first type of artifact, the first conventional residual network may also reduce or remove some of the second type of artifact, which may impact an ability of the second conventional residual network to learn to identify the second type of artifact. Similarly, the second conventional residual network may remove image data of the third type of artifacts, which may make it harder for the third conventional residual network to detect and remove a third type of artifact, and so on. As a result, remnants of the second, third, and/or other artifacts may be present in a final artifact-reduced image generated by a final chained conventional residual network. Additionally, an order of chaining the conventional residual networks matters, where different orders of conventional residual networks may result in different artifact-reduced images, of differing qualities.

An additional problem with chaining residual networks is that each chained residual network is dependent on an output from a preceding residual network. As a result, if or when adjustments are made to one chained model, adjustments may also have to be made to each of the other chained models. This reduces a robustness and flexibility of the solution, and may have regulatory implications.

Alternatively, the first, second, and third conventional residual networks may be trained in parallel on a same training dataset. The first, second, and third conventional residual networks may each be trained to output noise and artifact data of a specific type of artifact of a medical image. The noise and artifact data outputted by the first, second, and third conventional residual networks may then be added together to generate an artifact image (e.g., an artifact mask) and the artifact image may be subtracted from the medical image to remove the different types of artifacts. However, the first, second, and third conventional residual networks may each have difficulty achieving good performance on a single type of artifact, due to the variety of artifacts included in the training data.

To achieve a greater reduction in artifacts of various types in a medical image, a residual network architecture and training method are proposed herein that may more effectively remove artifacts of different types from a medical image using a single trained residual network. The proposed residual network may be trained on training data including various types of artifacts and noise profiles, and may use joint optimization to gradually decouple and extract the different types of artifacts. In accordance with the proposed method, different portions or stages of the proposed residual network architecture may estimate artifacts of different scales. That is, smaller scale, local artifacts (e.g., noise, rings, etc.) may first be estimated via a first set of layers of the proposed residual network architecture, and reduced or removed from the input image. Once the local noise and artifacts have been substantially reduced, larger scale, global artifacts (e.g., streaks, motion artifacts, etc.) may be estimated via a second set of layers of the proposed residual network architecture, and removed from the input image. Additional stages may used to further differentiate between the scales. For example, a first stage may be used to reduce artifacts of a first scale (e.g., low-level noise); a second stage may be used to reduce artifacts of a second scale (e.g., ring artifacts); a third stage may be used to reduce artifacts of a third scale (e.g., streaking artifacts); a fourth stage may be used to reduce artifacts of a fourth scale (e.g., motion artifacts); and so on.

By training the proposed residual network as described herein, artifacts of different types may be more effectively removed from medical images than by using conventional residual networks, including when a plurality of conventional residual networks are chained or trained in parallel. An additional advantage of the proposed method and model is that a number of constraints and dependencies on training set data may be reduced, where a wider range of images with varying degrees of noise, wider ranges of signal-to-noise ratios (SNR), and more types of artifacts may be included without increasing a training time or reducing a performance of the model due to over-representation of edge cases. In this way, a diagnostic image quality of medical images and an accuracy of image analysis and disease staging may be increased. Further, a robustness and consistency of medical imaging may be increased, which may reduce a number and/or duration of scans performed on a subject.

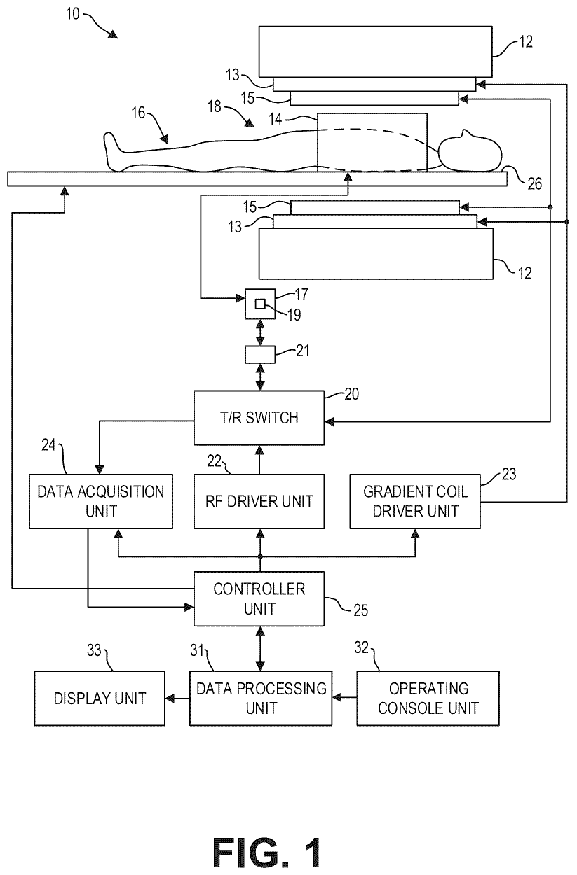

Referring now to the figures, FIG. 1 illustrates an exemplary imaging system as may be used to acquire medical imaging data. While FIG. 1 illustrates a magnetic resonance imaging (MRI) system, it should be understood that other medical imaging systems may be used without departing from the scope of this disclosure. FIG. 1 illustrates a magnetic resonance imaging (MRI) apparatus 10 that includes a magnetostatic field magnet unit 12, a gradient coil unit 13, an RF coil unit 14, an RF body or volume coil unit 15, a transmit/receive (T/R) switch 20, an RF driver unit 22, a gradient coil driver unit 23, a data acquisition unit 24, a controller unit 25, a patient table or bed 26, a data processing unit 31, an operating console unit 32, and a display unit 33. In some embodiments, the RF coil unit 14 is a surface coil, which is a local coil typically placed proximate to the anatomy of interest of a subject 16. Herein, the RF body coil unit 15 is a transmit coil that transmits RF signals, and the local surface RF coil unit 14 receives the MR signals. As such, the transmit body coil (e.g., RF body coil unit 15) and the surface receive coil (e.g., RF coil unit 14) are separate but electromagnetically coupled components. The MRI apparatus 10 transmits electromagnetic pulse signals to the subject 16 placed in an imaging space 18 with a static magnetic field formed to perform a scan for obtaining magnetic resonance signals from the subject 16. One or more images of the subject 16 can be reconstructed based on the magnetic resonance signals thus obtained by the scan.

The magnetostatic field magnet unit 12 includes, for example, an annular superconducting magnet, which is mounted within a toroidal vacuum vessel. The magnet defines a cylindrical space surrounding the subject 16 and generates a constant primary magnetostatic field B0.

The MRI apparatus 10 also includes a gradient coil unit 13 that forms a gradient magnetic field in the imaging space 18 so as to provide the magnetic resonance signals received by the RF coil arrays with three-dimensional positional information. The gradient coil unit 13 includes three gradient coil systems, each of which generates a gradient magnetic field along one of three spatial axes perpendicular to each other, and generates a gradient field in each of a frequency encoding direction, a phase encoding direction, and a slice selection direction in accordance with the imaging condition. More specifically, the gradient coil unit 13 applies a gradient field in the slice selection direction (or scan direction) of the subject 16, to select the slice; and the RF body coil unit 15 or the local RF coil arrays may transmit an RF pulse to a selected slice of the subject 16. The gradient coil unit 13 also applies a gradient field in the phase encoding direction of the subject 16 to phase encode the magnetic resonance signals from the slice excited by the RF pulse. The gradient coil unit 13 then applies a gradient field in the frequency encoding direction of the subject 16 to frequency encode the magnetic resonance signals from the slice excited by the RF pulse.

The RF coil unit 14 is disposed, for example, to enclose the region to be imaged of the subject 16. In some examples, the RF coil unit 14 may be referred to as the surface coil or the receive coil. In the static magnetic field space or imaging space 18 where a static magnetic field B0 is formed by the magnetostatic field magnet unit 12, the RF coil unit 15 transmits, based on a control signal from the controller unit 25, an RF pulse that is an electromagnet wave to the subject 16 and thereby generates a high-frequency magnetic field B1. This excites a spin of protons in the slice to be imaged of the subject 16. The RF coil unit 14 receives, as a magnetic resonance signal, the electromagnetic wave generated when the proton spin thus excited in the slice to be imaged of the subject 16 returns into alignment with the initial magnetization vector. In some embodiments, the RF coil unit 14 may transmit the RF pulse and receive the MR signal. In other embodiments, the RF coil unit 14 may be used for receiving the MR signals, but not transmitting the RF pulse.

The RF body coil unit 15 is disposed, for example, to enclose the imaging space 18, and produces RF magnetic field pulses orthogonal to the main magnetic field B0 produced by the magnetostatic field magnet unit 12 within the imaging space 18 to excite the nuclei. In contrast to the RF coil unit 14, which may be disconnected from the MRI apparatus 10 and replaced with another RF coil unit, the RF body coil unit 15 is fixedly attached and connected to the MRI apparatus 10. Furthermore, whereas local coils such as the RF coil unit 14 can transmit to or receive signals from a localized region of the subject 16, the RF body coil unit 15 generally has a larger coverage area. The RF body coil unit 15 may be used to transmit or receive signals to the whole body of the subject 16, for example. Using receive-only local coils and transmit body coils provides a uniform RF excitation and good image uniformity at the expense of high RF power deposited in the subject. For a transmit-receive local coil, the local coil provides the RF excitation to the region of interest and receives the MR signal, thereby decreasing the RF power deposited in the subject. It should be appreciated that the particular use of the RF coil unit 14 and/or the RF body coil unit 15 depends on the imaging application.

The T/R switch 20 can selectively electrically connect the RF body coil unit 15 to the data acquisition unit 24 when operating in receive mode, and to the RF driver unit 22 when operating in transmit mode. Similarly, the T/R switch 20 can selectively electrically connect the RF coil unit 14 to the data acquisition unit 24 when the RF coil unit 14 operates in receive mode, and to the RF driver unit 22 when operating in transmit mode. When the RF coil unit 14 and the RF body coil unit 15 are both used in a single scan, for example if the RF coil unit 14 is configured to receive MR signals and the RF body coil unit 15 is configured to transmit RF signals, then the T/R switch 20 may direct control signals from the RF driver unit 22 to the RF body coil unit 15 while directing received MR signals from the RF coil unit 14 to the data acquisition unit 24. The coils of the RF body coil unit 15 may be configured to operate in a transmit-only mode or a transmit-receive mode. The coils of the local RF coil unit 14 may be configured to operate in a transmit-receive mode or a receive-only mode.

The RF driver unit 22 includes a gate modulator (not shown), an RF power amplifier (not shown), and an RF oscillator (not shown) that are used to drive the RF coils (e.g., RF coil unit 15) and form a high-frequency magnetic field in the imaging space 18. The RF driver unit 22 modulates, based on a control signal from the controller unit 25 and using the gate modulator, the RF signal received from the RF oscillator into a signal of predetermined timing having a predetermined envelope. The RF signal modulated by the gate modulator is amplified by the RF power amplifier and then output to the RF coil unit 15.

The gradient coil driver unit 23 drives the gradient coil unit 13 based on a control signal from the controller unit 25 and thereby generates a gradient magnetic field in the imaging space 18. The gradient coil driver unit 23 includes three systems of driver circuits (not shown) corresponding to the three gradient coil systems included in the gradient coil unit 13.

The data acquisition unit 24 includes a pre-amplifier (not shown), a phase detector (not shown), and an analog/digital converter (not shown) used to acquire the magnetic resonance signals received by the RF coil unit 14. In the data acquisition unit 24, the phase detector phase detects, using the output from the RF oscillator of the RF driver unit 22 as a reference signal, the magnetic resonance signals received from the RF coil unit 14 and amplified by the pre-amplifier, and outputs the phase-detected analog magnetic resonance signals to the analog/digital converter for conversion into digital signals. The digital signals thus obtained are output to the data processing unit 31.

The MRI apparatus 10 includes a table 26 for placing the subject 16 thereon. The subject 16 may be moved inside and outside the imaging space 18 by moving the table 26 based on control signals from the controller unit 25.

The controller unit 25 includes a computer and a recording medium on which a program to be executed by the computer is recorded. The program when executed by the computer causes various parts of the apparatus to carry out operations corresponding to pre-determined scanning. The recording medium may comprise, for example, a ROM, flexible disk, hard disk, optical disk, magneto-optical disk, CD-ROM, or non-volatile memory card. The controller unit 25 is connected to the operating console unit 32 and processes the operation signals input to the operating console unit 32 and furthermore controls the table 26, RF driver unit 22, gradient coil driver unit 23, and data acquisition unit 24 by outputting control signals to them. The controller unit 25 also controls, to obtain a desired image, the data processing unit 31 and the display unit 33 based on operation signals received from the operating console unit 32.

The operating console unit 32 includes user input devices such as a touchscreen, keyboard and a mouse. The operating console unit 32 is used by an operator, for example, to input such data as an imaging protocol and to set a region where an imaging sequence is to be executed. The data about the imaging protocol and the imaging sequence execution region are output to the controller unit 25.

The data processing unit 31 includes a computer and a recording medium on which a program to be executed by the computer to perform predetermined data processing is recorded. The data processing unit 31 is connected to the controller unit 25 and performs data processing based on control signals received from the controller unit 25. The data processing unit 31 is also connected to the data acquisition unit 24 and generates spectrum data by applying various image processing operations to the magnetic resonance signals output from the data acquisition unit 24.

The display unit 33 includes a display device and displays an image on the display screen of the display device based on control signals received from the controller unit 25. The display unit 33 displays, for example, an image regarding an input item about which the operator inputs operation data from the operating console unit 32. The display unit 33 also displays a two-dimensional (2D) slice image or three-dimensional (3D) image of the subject 16 generated by the data processing unit 31.

Though a MRI system is described by way of example, it should be understood that the present techniques may also be useful when applied to images acquired using other imaging modalities, such as CT, tomosynthesis, PET, C-arm angiography, and so forth. The present discussion of an MRI imaging modality is provided merely as an example of one suitable imaging modality.

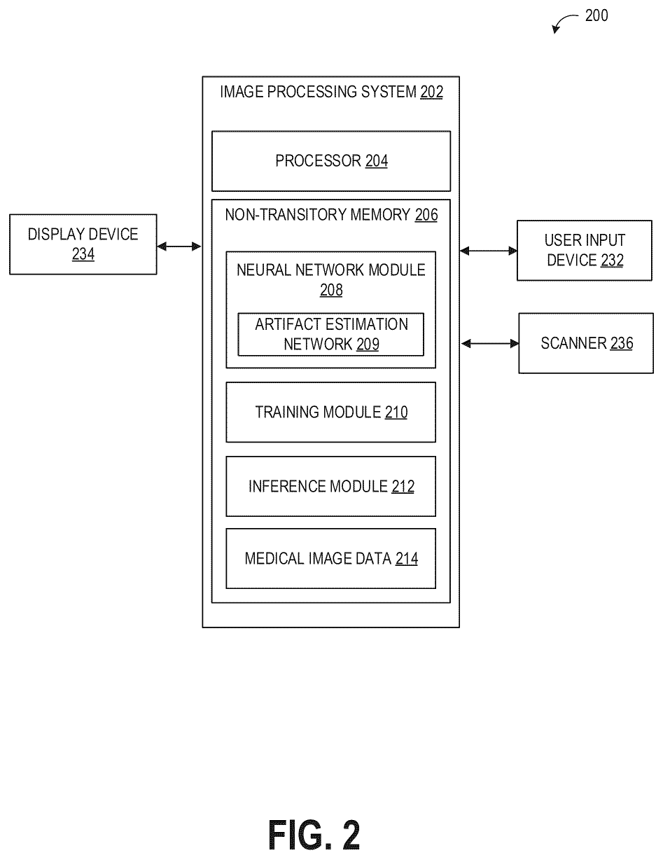

Referring now to FIG. 2, an image processing system 202 of a medical imaging system 200 is shown, in accordance with an embodiment. In some embodiments, at least a portion of image processing system 202 is disposed at a device (e.g., edge device, server, etc.) communicably coupled to the medical imaging system 200 via wired and/or wireless connections. In some embodiments, at least a portion of image processing system 202 is disposed at a separate device (e.g., a workstation) which can receive images from the medical imaging system 200 or from a storage device which stores the images/data generated by the medical imaging system 200.

Image processing system 202 includes a processor 204 configured to execute machine readable instructions stored in non-transitory memory 206. Processor 204 may be single core or multi-core, and the programs executed thereon may be configured for parallel or distributed processing. In some embodiments, the processor 204 may optionally include individual components that are distributed throughout two or more devices, which may be remotely located and/or configured for coordinated processing. In some embodiments, one or more aspects of the processor 204 may be virtualized and executed by remotely-accessible networked computing devices configured in a cloud computing configuration.

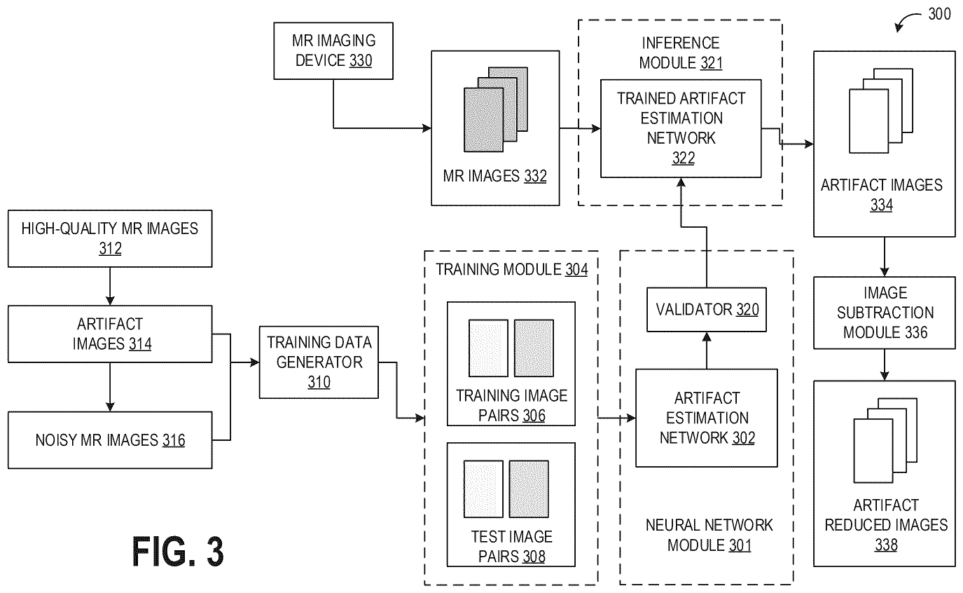

Non-transitory memory 206 may store a neural network module 208, a network training module 210, an inference module 212, and medical image data 214. Neural network module 208 may include one or more DL networks and instructions for implementing the DL networks to reduce or optionally remove noise from a medical image of the medical image data 214, as described in greater detail below. Neural network module 208 may include one or more trained and/or untrained neural networks and may further include various data, or metadata pertaining to the one or more neural networks stored therein. In particular, neural network module may store an artifact estimation network 209, described in greater detail below in reference to FIGS. 3-10.

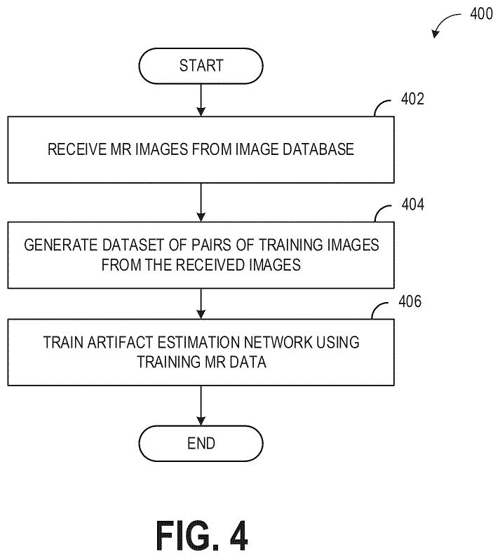

Training module 210 may comprise instructions for training one or more of the neural networks implementing the artifact estimation network 209 and/or other DL models stored in neural network module 208. In particular, training module 210 may include instructions that, when executed by the processor 204, cause image processing system 202 to conduct one or more of the steps of method 400 for training the artifact estimation network 209 in a training stage, discussed in more detail below in reference to FIGS. 3 and 4. In some embodiments, training module 210 includes instructions for implementing one or more gradient descent algorithms, applying one or more loss functions, and/or training routines, for use in adjusting parameters of the one or more neural networks of neural network module 208. Inference module 212 may comprises instructions for reducing an amount of artifacts in new image data with the trained DL model.

In some embodiments, the non-transitory memory 206 may include components disposed at two or more devices, which may be remotely located and/or configured for coordinated processing. In some embodiments, one or more aspects of the non-transitory memory 206 may include remotely-accessible networked storage devices configured in a cloud computing configuration.

Image processing system 202 may be operably/communicatively coupled to a user input device 232 and a display device 234. User input device 232 may comprise one or more of a touchscreen, a keyboard, a mouse, a trackpad, or other device configured to enable a user to interact with and manipulate data within image processing system 202. Display device 234 may include one or more display devices utilizing virtually any type of technology. In some embodiments, display device 234 may comprise a computer monitor, and may display medical images. Display device 234 may be combined with processor 204, non-transitory memory 206, and/or user input device 232 in a shared enclosure, or may be peripheral display devices and may comprise a monitor, touchscreen, projector, or other display device known in the art, which may enable a user to view medical images produced by a medical imaging system, and/or interact with various data stored in non-transitory memory 206. In some examples, the display device 234 may be the display unit 33 of FIG. 1 and the user input device 232 may be at least part of the operating console unit 32 of FIG. 1.

Non-transitory memory 206 further stores medical image data 214. Medical image data 214 may include for example, medical images acquired via a scanner 236, which may be an MR scanner, a CT scanner, a scanner for spectral imaging, or a different imaging modality. Image processing system 202 may be operably/communicatively coupled to the scanner 236. The scanner 236 may be any imaging device configured to image a subject such as a patient, an inanimate object, one or more manufactured parts, and/or foreign objects such as dental implants, stents, and/or contrast agents present within the body, such as MRI apparatus 10 of FIG. 1. Image processing system 202 may receive imaging data from scanner 236, process the received imaging data via processor 204 based on instructions stored in one or more modules of non-transitory memory 206, and/or store the received imaging data in medical image data 214.

It should be understood that image processing system 202 shown in FIG. 1 is for illustration, not for limitation. Another appropriate image processing system may include more, fewer, or different components.

Referring to FIG. 3, an example of an artifact estimation network training system 300 is shown, which may be used to train a neural network such as an artifact estimation network 302. Artifact estimation network 302 may be trained to estimate artifacts in two-dimensional (2D) or three-dimensional (3D) medical images in accordance with one or more operations described in greater detail below in reference to method 400 of FIG. 4. The estimated artifacts may then be extracted from the 2D or 3D images, resulting in artifact-reduced images. Artifact estimation network training system 300 may be implemented by an image processing system, such as image processing system 202 of FIG. 2, to train artifact estimation network 302 to estimate artifacts in MR images, or different types of medical images, which may then be reduced or removed.

In some embodiments, artifact estimation network 302 may be a deep neural network with a plurality of hidden layers. In one embodiment, artifact estimation network 302 is a convolutional neural network (CNN) such as a residual neural network, as described in greater detail below. Artifact estimation network 302 may be stored within a neural network module 301 of the image processing system, which may be a non-limiting example of neural network module 208 of image processing system 202 of FIG. 2.

Artifact estimation network training system 300 includes a training module 304, which may be a non-limiting example of training module 210 of image processing system 202 of FIG. 2. Training module 304 includes a training dataset comprising a plurality of training pairs of data, such as image pairs, divided into training image pairs 306 and test image pairs 308, that are used to train artifact estimation network 302. A number of training image pairs 306 and test image pairs 308 may be selected to ensure that sufficient training data is available to prevent overfitting, whereby the artifact estimation network 302 learns to map features specific to samples of the training set that are not present in the test set.

Each image pair of the training image pairs 306 and the test image pairs 308 comprises an input image and a target image. In various embodiments, the input images may be noisy MR images 316 generated from high-quality MR images 312, by combining one or more artifact images 314 with a high-quality MR image 312. Combining the one or more artifact images 314 with the high-quality MR image 312 may include, for each pixel of the high-quality MR image 312, adding pixel intensity values of corresponding pixels each artifact image 314 of the one or more artifact images 314 to a pixel intensity value of the pixel. For example, a first pixel intensity value of a pixel at a first location of a first high-quality MR image 312 may be added to a first pixel intensity value of a first pixel at the same location of a first artifact image 314 and a second pixel intensity value of a second pixel at the same location of a second artifact image 314; and so on for each pixel. The high-quality MR images may be real MR images collected from patients using real scanners that have little or no artifacts. In some embodiments, the high-quality MR images may be synthesized images. The artifact images 314 may include synthesized images of various types of artifacts. The various types of artifacts may include local noise, ring artifacts, streaking, aliasing, etc. The artifact images 314 may be combined with the high-quality MR images 312 to create a respective set of noisy MR images 316.

For example, a first set of one or more synthesized artifact images 314 may be added to a first high-quality MR image 312 to generate a first noisy MR image 316, which may be the input image of a first training image pair 306; and the first set of one or more synthesized artifact images 314 may be combined to generate a combined-artifact target image of the first training image pair 306. A second set of one or more synthesized artifact images 314 may be added to a second high-quality MR image 312 to generate a second noisy MR image 316, which may be the input image of a second training image pair 306; and the second set of one or more synthesized artifact images 314 may be combined to generate the target image of the second training image pair 306. A third set of one or more synthesized artifact images 314 may be added to a third high-quality MR image 312 to generate a third noisy MR image 316, which may be the input image of a third training image pair 306; and the third set of one or more synthesized artifact images 314 may be combined to generate the target image of the third training image pair 306; and so on. The first, second, and third sets of one or more synthesized artifact images 314 may include the same, similar, or different artifacts, types of artifacts, and/or numbers of artifacts. In this way, a robust set of training data may be generated with a 1:1 correspondence between the input images and the target images. In some embodiments, each synthesized artifact image may be saved separately as one of the target images of the training image pair.

In other embodiments, artifact estimation network 302 may be trained using different input and target image pairs. For example, in some embodiments, each training image pair 306 may comprise a noisy MR image 316 as an input image, and a corresponding high-quality image 312 as a target image, where the noisy MR image 316 is generated by combining one or more artifact images 314 to the corresponding high-quality image 312. In such embodiments, artifact estimation network 302 may be trained, in accordance with a similar training procedure as that described herein, to output artifact-reduced images 338 rather than artifact images 334.

Artifact estimation network training system 300 may include a training data generator 310, which may be used to generate image pairs. The noisy MR images 316 may be paired with the artifact images 314 by training data generator 310, as described above. Once each image pair is generated, the image pair may be assigned to either the training image pairs 306 or the test image pairs 308. In an embodiment, the image pair may be assigned to either the training image pairs 306 or the test image pairs 308 randomly in a pre-established proportion. Artifact estimation network 302 may be trained on the training image pairs to output one or more artifact images 314 associated with each noisy MR image 316. That is, artifact estimation network 302 may be trained to extract artifacts from the noisy MR image 316 and output multiple artifact images or a combined artifact image including the extracted artifacts, such that the extracted artifact image may be subtracted from the noisy MR image 316, at a subtraction module 336, to obtain an artifact-reduced image that is the same as or similar to the high-quality MR image 312 used to generate the noisy MR image 316. Subtracting the artifact image from the noisy MR image 316 may include subtracting a first pixel intensity of each pixel of the artifact image from a corresponding second pixel intensity of a pixel of the noisy MR image 316 at a same pixel location. Additionally, in various embodiments, artifact-reduced images may be generated that extract different artifacts at different stages of a plurality of stages of artifact estimation network 302. As described in greater detail below in reference to FIGS. 4, 5, and 6, at the end of each stage, an artifact image that extracts a single artifact type may be outputted and subtracted from the noisy MR image 316 to produce a partially cleaned MR image with the single artifact type reduced or removed. The partially cleaned MR image may then be inputted into a subsequent stage of artifact estimation network 302. In this way, artifacts may be sequentially outputted and removed until estimating the last type of artifact or obtaining a final artifact-reduced image with various types of artifacts removed or reduced.

Artifact estimation network training system 300 may include a validator 320 that validates the performance of the artifact estimation network 302 against the test image pairs 308. The validator 320 may take as input a partially trained artifact estimation network 302 and a dataset of test image pairs 308, and may output an assessment of the performance of the partially trained artifact estimation network 302 on the dataset of test image pairs 308.

Once the artifact estimation network 302 has been validated, a trained artifact estimation network 322 (e.g., the validated artifact estimation network 302) may be used to generate a set of artifact images 334 from a set of acquired MR images 332. That is, for each MR image 332, trained artifact estimation network 322 may output one or more corresponding artifact images including estimated artifacts extracted from the MR image 332 (e.g., and no anatomical image data of the subject), at one or more stages of trained artifact estimation network 322. The MR images 332 may include local and global artifacts. For example, the MR images 332 may be acquired by an MR imaging device 330, which may be a non-limiting version of scanner 236 of FIG. 2. Trained artifact estimation network 322 may be stored within an inference module 321 of the image processing system (e.g., inference module 212 of FIG. 2).

For each of the MR images 332, the one or more artifact images 334 outputted by the trained artifact estimation network 322 may then be subtracted from a corresponding input MR image 332 to generate an artifact-reduced image 338, where the artifact-reduced image 338 is a version of the MR image 332 with artifacts reduced or removed.

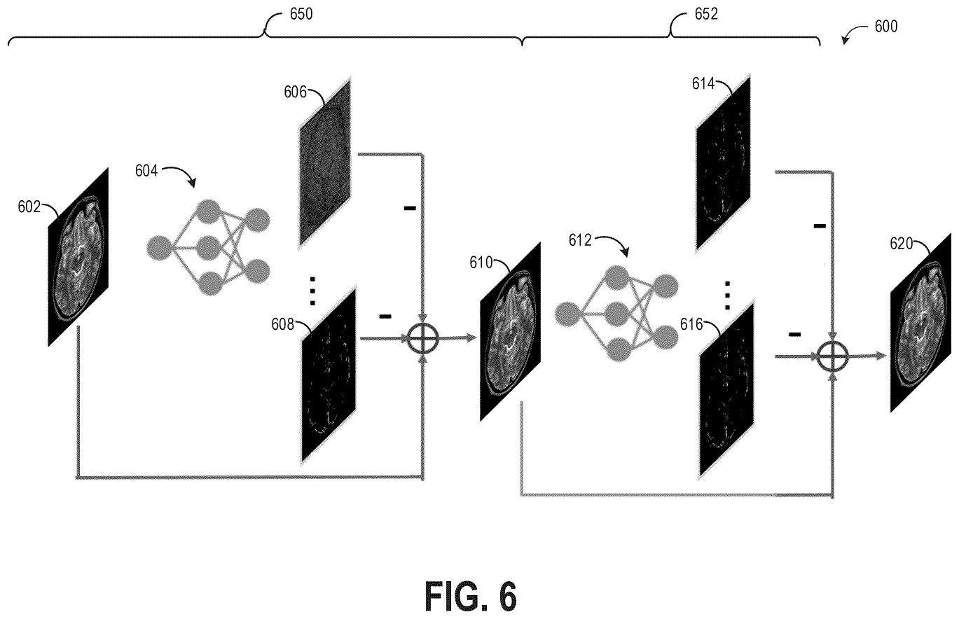

Artifact estimation network 302 and trained artifact estimation network 322 may be residual CNNs, where layers of artifact estimation network 302 may be grouped into residual blocks and skip connections are employed to propagate input data in a manner that bypasses one or more residual blocks. In contrast to conventional residual networks, the artifact estimation network may have a concatenated, multi-stage network architecture, as described below in reference to FIGS. 6-8.

Referring now to FIG. 6, a high-level architecture diagram of a residual neural network 600 is shown, which may be the artifact estimation network herein described. Residual neural network 600 may be used to estimate artifacts from MR images acquired by an MR imaging system, such as MRI apparatus 10 of FIG. 1. Residual neural network 600 may be trained in an artifact estimation network training system, such as artifact estimation network training system 300 of FIG. 3.

Residual neural network 600 may be a concatenated residual neural network including a first stage 650, and a second stage 652, where each of the first stage 650 and the second stage 652 may have an input layer, a plurality of convolutional layers, and a stage output layer. While two stages are shown in FIG. 6, in other embodiments, residual neural network 600 may include one or more additional stages. Each of first stage 650, second stage 652, and any additional stages may focus on estimating artifacts of a certain scale from an input image. For example, first stage 650 may detect and reduce local artifact data from the input image, such as noise, ringing artifacts, etc. Second stage 652 may detect and reduce global artifact data from the input image, such as streaking artifacts, motion artifacts, etc. In other examples, a first stage may focus on estimating and extracting noise; a second stage may focus on estimating and extracting ringing artifacts; a third stage may focus on estimating and extracting streaking artifacts; and a fourth stage may focus on estimating and extracting motion artifacts. In yet other examples, different or additional stages may be included in residual network 600.

If an embodiment of residual neural network 600 includes additional stages, artifact types may be categorized based on scale, and each stage of the three stages may focus detecting and reducing artifact data of a different scale from the input image. For example, a first stage may estimate and reduce a most-local type of artifact (e.g., noise); a second stage may estimate and reduce a next-most-local type of artifact (e.g., ring artifacts); a third stage may estimate and reduce a next-most-local type of artifact (e.g., streaking artifacts); and so on, until a final stage that estimate and reduces a most-global type of artifact. At each stage, residual neural network 600 estimates and removes noise or artifacts of a respective scale, while leaving as much image data relating to higher-level artifacts as possible, so that subsequent stages may be more efficiently trained to estimate the higher-level artifacts.

For example, in the depicted embodiment, first stage 650 may reduce noise and ring artifacts in a medical image, while removing little or no artifact data corresponding to streaking artifacts and motion artifacts. As a result of removing the noise and ring artifact data, second stage 652 may achieve a higher performance at detecting and reducing the streaking artifacts and motion artifacts. In contrast, a conventional residual neural network may achieve a lower performance at detecting the noise and ring artifact data, as a result of a presence of noise and ring artifacts in the medical image.

During training of residual neural network 600, an input image 602 of an image pair (e.g., training image pairs 306) may be inputted into a first set of convolutional layers 604 of the first stage 650. Input image 602 may be a medical image such as an MR image, including anatomical features of a subject of input image 602. Image data of input image 602 may be propagated through the first set of convolutional layers 604, to one or more stage 1 output layers of the first set of convolutional layers 604. The stage 1 output layers may comprise a plurality of stage 1 output nodes, where an output of each stage 1 output node may represent a feature map of artifact data. Each artifact may be represented by a single stage 1 output layer. That is, each feature map may include artifact data of a specific type of artifact corresponding to the scale of the artifact data addressed by the first stage 650. For example, a first stage 1 output layer may output a first set of feature maps 606 (e.g., one for each node of the first stage 1 output layer) including artifact data corresponding to noise; and a second stage 1 output layer may output a second set of feature maps 608 (e.g., one for each node of the second stage 1 output layer) including artifact data corresponding to ring artifacts.

A first stage-specific artifact image may be generated from one or more feature maps of one or more stage 1 output layers, each feature map representing local artifact types. Thus, the first stage-specific artifact image may include artifact data corresponding to local artifacts (e.g., noise and ringing artifacts) of input image 602, and not image data of the anatomical features of input image 602 or image data of other types of global artifacts. The one or more first stage-specific artifact images may then be subtracted from input image 602 (e.g., pixel intensity values of each pixel of the stage-specific artifact image may be subtracted from a pixel intensity value of a corresponding pixel of input image 602) to generate a partially cleaned image 610, where partially cleaned image 610 may be a version of input image 602 where local artifacts have been reduced. However, other types of artifacts, such as global artifacts, may be present in partially cleaned image 610.

Partially cleaned image 610 may then be inputted into a second set of convolutional layers 612 of the second stage 652. The second set of convolutional layers 612 may be configured differently from the first set of convolutional layers 604, and configured specifically to estimate global artifact features. For example, nodes of the second set of convolutional layers 612 may be configured to have a larger reception field than nodes of the first set of convolutional layers 604. Image data of partially cleaned image 610 may be propagated through the second set of convolutional layers 612, to one or more stage 2 output layers of the second set of convolutional layers 612. The stage 2 output layers may each comprise a plurality of stage 2 output nodes. An output of each stage 2 output node may represent a feature map of artifact data of a specific type of artifact corresponding to the scale of the artifact data addressed by the second stage 652. Each artifact may be represented by a single stage 2 output layer. For example, a first stage 2 output layer may output a first set of feature maps 614 including artifact data corresponding to streaks in partially cleaned image 610; a second stage 2 output layer may output a second set of feature maps 616 including artifact data corresponding to motion artifacts in partially cleaned image 610; a third stage 2 output layer may include artifact data corresponding to a third type of global artifacts; and so on.

The feature maps of each stage 2 output node may then be added together to create a global artifact image, where the global artifact image includes global artifact data of input image 602 (and partially cleaned image 610), and not local artifact image data or image data of the anatomical features of input image 602. The global artifact data of the global artifact image may include artifact data of the different types of global artifacts estimated at each stage 2 output node of the stage 2 output layer, and may not include artifact data of other types of artifacts. The global artifact image may be subtracted from partially cleaned image 610 to generate an artifact-reduced image 620, where artifact-reduced image 620 may be a version of input image 602 where both global and local artifacts have been reduced.

In various embodiments, the global artifact image may be an output of residual neural network 600 comprising a first 2D matrix of values, wherein each value of the first 2D matrix of values corresponds to a pixel of input image 602. Artifact-reduced image 620 is then generated by subtracting the first 2D matrix of values from a second 2D matrix of values corresponding to distinct intensities of pixels of partially cleaned image 610. In other embodiments, artifact-reduced image 620 may be an output of residual neural network 600, where artifact-reduced image 620 is a second 2D matrix of values, each value corresponding to a pixel of input image 602, wherein a distinct intensity of each pixel of artifact-reduced image 620 generates a reconstruction of input image 602 where an amount of artifacts in one or more regions of artifact-reduced image 620 is lower than an amount of artifacts in the one or more regions of input image 602.

The global artifact image may then be compared to a target image of the image pair, which may be a ground truth artifact image. A difference, or loss between the global artifact image and the ground truth artifact image may be calculated using a loss function. The loss may then be backpropagated first through second stage 652 and then through first stage 650. As the loss is backpropagated, parameters of nodes of each convolutional layer of the first and second sets of convolutional layers 604 and 612 may be adjusted, using techniques known in the art.

Additionally, in some embodiments, different weightings may be assigned to different types of artifacts, to preferentially increase or decrease a relative performance of residual network 600 on each different type of artifact. That is, prior to adding the feature maps of each output node of the first set of convolutional layers 604 to create the combined local artifact image and subtracting the local artifact image from input image 602 to generate partially cleaned image 610, the image data included in each feature map may be multiplied by a weight value to increase or decrease a relative contribution of the feature map towards the local artifact image. Similarly, prior to adding the feature maps of each stage 2 output node of the second set of convolutional layers 612 to create the combined global artifact image and subtracting the global artifact image from partially cleaned image 610 to generate artifact-reduced image 620, the image data included in each stage 2 feature map may be multiplied by a weight value to increase or decrease a relative contribution of the stage 2 feature map towards the global artifact image. For example, if the user prefers an image with a medium SNR, a first set of feature maps corresponding to noise in the image may be assigned a lower weight than a second set of feature maps corresponding to the streaking artifacts. In this way, the effectiveness of artifacts removal may be tuned to meet user's preference.

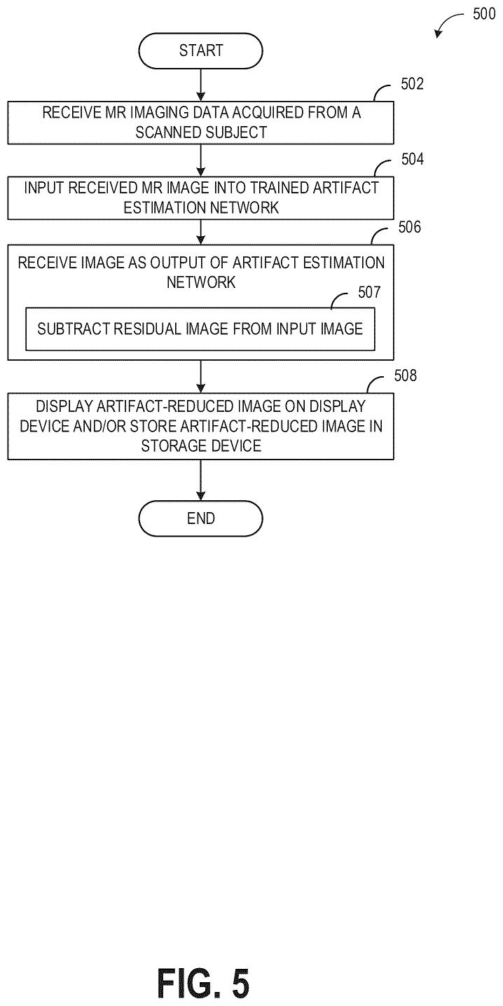

After training, during a subsequent inference stage, a trained residual neural network 600 may be used to reduce or remove artifacts of various types and at various scales from new medical images, such as images generated by an imaging device during an examination of a patient (e.g., MR imaging device 330 of FIG. 3). The application of the trained residual neural network 600 during the inference stage is described in greater detail below in reference to the method of FIG. 5.

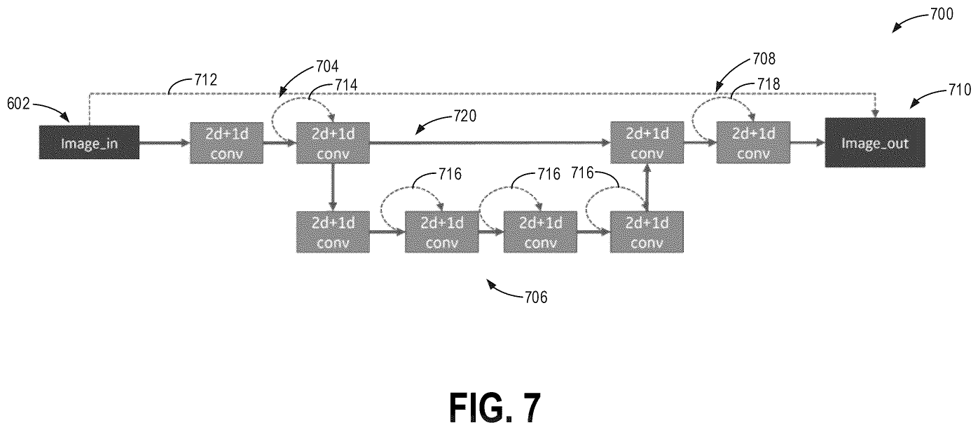

FIG. 7 shows a first architectural diagram of a stage 700 of a residual neural network 600. Stage 700 may correspond to either or both of first stage 650 and/or second stage 652 of residual neural network 600. As described above, stage 700 may have an input layer, a plurality of convolutional layers, and an output layer. In the input layer, input image 602 may be inputted into stage 700 and mapped to a set of features. Stage 700 may include a series of mappings, from the input image 602 through a plurality of iterative images (e.g., trainable blocks). For example, the input image 602 may be mapped to a first set of iterative images 704. The first set of iterative images 704 may be mapped to a second set of iterative images 706 and to a third set of iterative images 708. Each iterative image of the first set of iterative images 704, the second set of iterative images 706, and the third set of iterative images 708 may have a convolutional kernel of a different size.

The second set of iterative images 706 may also be mapped to the third set of iterative images 708, as demonstrated by solid arrows 720. The third set of iterative images 708 may be mapped to an output image 710. In some examples, images may also have residual connections, as represented in the diagram by dashed lines. For example, a first residual connection 712 may exist between the input image 602 and the output image 710; second residual connections 714 may exist between each of the iterative images of the first set of iterative images 704; third residual connections 716 may exist between each of the iterative images of the second set of iterative images 706; and fourth residual connections 718 may exist between each of the iterative images of the third set of iterative images 708. Each of the iterative images may be connected to a previous image and to a next image, wherein each iterative image receives input from a previous iterative image and transforms/maps the received input to an output to produce a next iterative image. In some examples, convolutional kernel size may increase or decrease between iterative images and in other examples, convolutional kernel size may be maintained between iterative images.

The output image 710 may be an estimated image based on the input image 602 and the plurality of iterative images based on input layers and output layers of the stage 700. The output image 710 may approximate a reference image based on the training of the stage 700, where the reference image is a target image of a pair of training images. Thus, the stage 700 illustrates a map of transformations that occur as input image 602 is propagated through layers of the network.

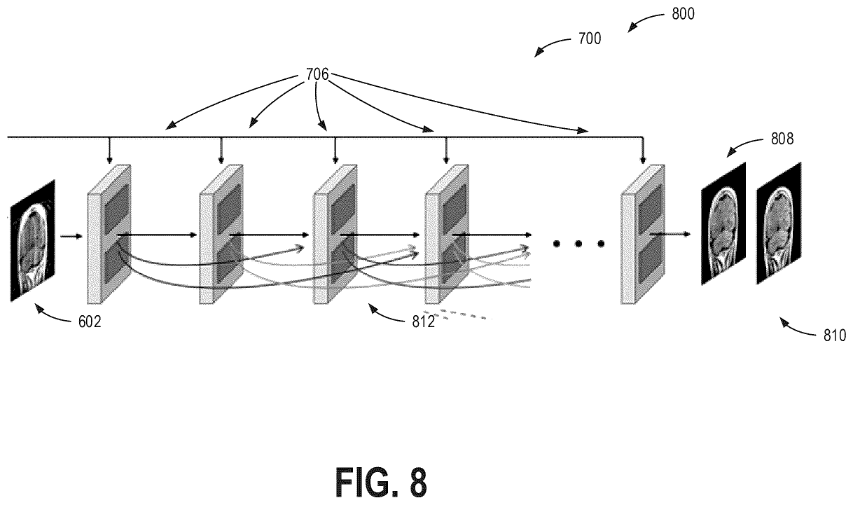

FIG. 8 shows a second architectural diagram 800 of stage 700 of residual neural network 600, where input image 602 is shown as being mapped to a set of features as described above. Second architectural diagram 800 illustrates a map of transformations that occur as input image 602 is propagated through layers of stage 700 and the plurality of iterative images 706. Each of the iterative images 706 may be connected to a previous image and to a next image, wherein each iterative image receives input from a previous iterative image and transforms/maps the received input to an output to produce a next iterative image. Further, residual connections 812 may be present between non-adjacent iterative images. An nth iterative image may map to an output image 808 (e.g., partially cleaned image 610 or artifact-reduced image 620). Output image 808 may be an estimated image based on the input image 602 and the plurality of iterative images 706 based on input layers and output layers of stage 700. The output image 808 may approximate a reference image 810 based on the training of stage 700, where the reference image 810 is a target image of a pair of training images.

Turning now to FIG. 4, a flowchart illustrating a method 400 for training an artifact estimation network is shown. The artifact estimation network may be a non-limiting example of the artifact estimation network 302 of the artifact estimation network training system 300 of FIG. 3, and/or residual neural network 600 of FIGS. 6-8. Method 400 may be executed by a processor of an image processing system, such as the image processing system 202 of FIG. 2. In an embodiment, some operations of method 400 may be stored in non-transitory memory of the image processing system (e.g., in a training module such as the training module 210 of the image processing system 202) and executed by a processor of the image processing system (e.g., the processor 204 of image processing system 202).

Method 400 begins at 402, where method 400 includes receiving MR images for training the artifact estimation network. In various embodiments, the MR images may be stored in a medical image dataset of the image processing system, such as the medical image data 214 of image processing system 202 of FIG. 2. It should be understood that while the method 400 and the other methods included in the present disclosure are described herein with respect to MRI imaging and MR images, method 400 and the other methods may be applied to other imaging modalities without departing from the scope of this disclosure.

At 404, method 400 includes generating a dataset of pairs of training images from the received images. The artifact estimation network may be trained on training data comprising sets of image pairs. Each image pair of the sets of image pairs may include a set of target artifact images (e.g., artifact images 314 of FIG. 3) including artifacts, and a noisy MR image (e.g., noisy MR images 316) as an input image, where the noisy MR image is a combination of a high-quality MR image having few or no artifacts (e.g., high-quality MR images 312) and the artifact images. The artifact images may be a combination of various artifact images including different types of artifacts, as described above.

At 406, method 400 includes training the artifact estimation network on the training pairs. More specifically, training the artifact estimation network on the image pairs includes training the artifact estimation network to learn to extract the artifacts from the noisy MR images. The artifact estimation network may include one or more convolutional layers, which in turn comprise one or more convolutional filters (e.g., a convoluted neural network architecture). Further, the artifact estimation network may be a concatenated residual network with a plurality of stages, as described above in reference to FIG. 6, where each stage of the plurality of stages is configured and trained to detect and reduce artifacts of a given scale. In some embodiments, the artifact estimation network may comprise a residual neural network having a U-net architecture.

The convolutional filters of the artifact estimation network may comprise a plurality of weights, wherein the values of the weights are learned during a training procedure. The convolutional filters may correspond to one or more visual features/patterns, thereby enabling the artifact estimation network to identify and extract features from the medical images.

Training the artifact estimation network on the image pairs may include iteratively inputting an input image of each training image pair into an input layer of the artifact estimation network. In some embodiments, each pixel intensity value of the input image may input into a distinct neuron of the input layer of the artifact estimation network. The artifact estimation network input image may be propagated from the input layer, through a plurality of hidden layers, to an output layer of the artifact estimation network. The plurality of hidden layers may be organized into a plurality of residual blocks, where each residual block includes one or more convolutional layers, and residual (e.g., skip) connections are used to bypass one or more residual blocks during a forward propagation stage or a backpropagation stage of training.

In various embodiments, the output of the artifact estimation network may be a residual image including extracted artifact data, and not including features of the input image. Image data of the residual image may be subtracted from the input image to generate an artifact-reduced image (as described above in reference to FIG. 3), where the artifact-reduced image has a reduced amount of artifacts in comparison to the input image. Note that the artifact estimation network may also output artifact images generated at each stage of the artifact estimation network, which may each be subtracted from the input image to generate the artifact-reduced image.

The artifact estimation network may be configured to iteratively adjust one or more of the plurality of weights of the artifact estimation network during backpropagation, in order to minimize a loss function, based on an assessment of differences between the input image and the target image comprised by each image pair of the training image pairs. In one embodiment, the loss function is a Mean Absolute Error (MAE) loss function, where differences between the input image and the target image are compared on a pixel-by-pixel basis and summed. In another embodiment, the loss function may be a Structural Similarity Index (SSIM) loss function. In other embodiments, the loss function may be a minimax loss function, or a Wasserstein loss function. It should be appreciated that the examples provided herein are for illustrative purposes, and other types of loss function may be used without departing from the scope of this disclosure.

The weights and biases of the artifact estimation network may be adjusted based on a difference between the output image and the target (e.g., ground truth) image of the relevant image pair. The difference (or loss), as determined by the loss function, may be backpropogated through the neural learning network to update the weights (and biases) of the convolutional layers. The loss may be backpropagated through each stage of the artifact estimation network in a reverse order of the stages. The loss of each stage may also be combined as a single backpropagation to jointly optimize the network. The backpropagation may also be a combination of the two approaches described above, e.g., by conducting backpropagation for joint loss first, and then conducting backpropagation for each loss separately. For example, at the end of a first stage, a first loss may be calculated based on a first set of target artifact images of a training pair, and at the end of a second stage, a second loss may be calculated based on a second set of target artifact images of the training pair. In some embodiments, back propagation of each loss, or the joint loss, may occur according to a gradient descent algorithm, wherein a gradient of the loss function (a first derivative, or approximation of the first derivative) is determined for each weight and bias of the deep neural network. Each weight (and bias) of the artifact estimation network is then updated by adding the negative of the product of the gradient determined (or approximated) for the weight (or bias) with a predetermined step size. Updating of the weights and biases may be repeated until the weights and biases of the artifact estimation network converge, or the rate of change of the weights and/or biases of the deep neural network for each iteration of weight adjustment are under a threshold.

In order to avoid overfitting, training of the artifact estimation network may be periodically interrupted to validate a performance of the artifact estimation network on the test image pairs. In an embodiment, training of the artifact estimation network may end when a performance of the artifact estimation network on the test image pairs converges (e.g., when an error rate on the test set converges on or to within a threshold of a minimum value). In this way, the artifact estimation network may be trained to extract artifact data from an input image.

In some embodiments, an assessment of the performance of the artifact estimation network may include a combination of a minimum error rate and a quality assessment, or a different function of the minimum error rates achieved on each image pair of the test image pairs and/or one or more quality assessments, or another factor for assessing the performance of the artifact estimation network. In other examples, other loss functions, error rates, quality assessments, and/or performance assessments may be used during training.

Referring now to FIG. 5, a flowchart is shown of a method 500 for deploying an artifact estimation network, such as artifact estimation network 302 of FIG. 3 and/or residual neural network 600 of FIGS. 6-8, to estimate and reduce an amount of artifacts of different types in medical images, such as MR images. Method 500 may be executed by a processor of an image processing system, such as the image processing system 202 of FIG. 2. Some operations of method 500 may be stored in a non-transitory memory of the image processing system (e.g., in inference module 212) and executed by a processor of the image processing system (e.g., the processor 204). In various embodiments, the artifact estimation network may be trained as described above in reference to method 400 of FIG. 4.

Method 500 begins at 502, where method 500 includes receiving MR imaging data acquired from a scanned subject. The MR imaging data may comprise, as an example, an MR image of the subject. For example, the MR image may be acquired using an MRI device such as MR imaging device 330 of FIG. 3, or scanner 236 of image processing system 202. The acquired MR image may be of a same region of interest, and/or may include a same set of anatomical structures as the set of training images on which the artifact estimation network is trained. In some embodiments, the subject of the acquired MR image may be similar to subjects of the set of training images. In some examples, a plurality of artifact estimation networks may be trained on different types of subject, or different anatomies of a subject, and the artifact estimation network may be selected from the plurality of artifact estimation networks based on the same set of anatomical structures and/or the type of subject. For example, the subject may be a child, where the acquired MR image may be inputted into a first artifact estimation network trained on RGB images of children; the subject may be female, where the acquired MR image may be inputted into a second artifact estimation network trained on reference images of women; the subject may be male, where the acquired MR image may be inputted into a third artifact estimation network trained on reference images of men; and so on.

At 504, the acquired MR imaging data is inputted into the trained artifact estimation network. In various embodiments, inputting the acquired MR imaging data into the trained artifact estimation network comprises inputting image data of each pixel of the acquired MR image into a corresponding node of an input layer of the artifact estimation network. Values of the image data may be multiplied by weights at the corresponding nodes, and propagated through various hidden layers (e.g., convolutional layers) of each residual block of each stage of the artifact estimation network to a final output layer of the artifact estimation network. The output layer may include nodes corresponding to each pixel of an output image, where the output image is based on image data outputted by each node. At 506, method 500 includes receiving the output image from the artifact estimation network. In various embodiments, the output image may be an artifact image including artifacts extracted from the acquired MR (e.g., input) image. In other embodiments, the output image may be an artifact-reduced image with less artifacts than the input image, where an amount of the artifacts of the input image is reduced or removed by the trained artifact estimation network.

At 507, method 500 optionally includes subtracting the output image from the input image to generate the artifact-reduced image. As described above, in some examples, the artifact estimation network may be trained to output an artifact image, where the artifact image includes image data of artifacts of the input image and not image data of the anatomical structures and/or features of the input image. In such cases, the image data of the artifacts may be subtracted from the image data of the input image, with the image data of the anatomical structures and/or features of the input image remaining in the artifact-reduced image. In some examples, artifact images may be outputted by each stage of the artifact estimation network, and the artifact images may be subtracted from the input image.

As described above in reference to FIGS. 3 and 4, a partially cleaned image may be generated at each stage of the trained artifact estimation network, where the partially cleaned image may be a version of the input image with artifacts of a given scale (and/or artifacts of a specific type) are reduced or removed by subtracting one or more stage-specific artifact images outputted by the artifact estimation network. As described above in reference to FIG. 6, in some scenarios, tuning parameters may be applied to image data of stage-specific artifact images generated at each stage to increase or decrease a contribution of the image data to subsequent stages of the trained artifact estimation network, thereby adjusting an amount of the relevant artifact type reduced in the stage-specific artifact image. For example, a user may wish to extract certain artifact types while leaving some noise in the final artifact-reduced image. To accomplish this, the user may specify a tuning parameter between 0 and 1 to be multiplied by each pixel intensity value of each pixel in the stage-specific artifact image, prior to subtracting the stage-specific artifact image from an image inputted into the relevant stage. For example, the tuning parameter may be set in a preferences file of the image processing system by the user, or tuning parameters may be assigned by the image processing system based on a desired artifact profile specified by the user in a different manner. In this way, tuning parameters may be used to weight different types of artifacts in the artifact images, to adjust the level of artifact reduction/removal overall to accommodate different user preferences.

In some examples, an artifact weighting scheme may be submitted to the image processing system by the user via a selection from a menu displayed on the display screen, for example, within a software application used to display the input image and/or the artifact-reduced image on the display screen. For example, the user may select a menu item for adjusting a weighting of different types of artifacts that are desired to be removed. A lookup table may be used to determine one or more nodes of the artifact estimation network that generate feature maps associated with the selected artifact types, and the artifact weighting scheme may be applied to the nodes. In one example, the artifact weighting scheme may be applied when subtracting a stage-specific artifact image from the input image at a relevant stage (e.g., stage 650, 652) of the artifact estimation network in accordance with the following equation:

$${I}_{f i n a l} = {I}_{i n p u t} - {\sum }_{i = 1}^{n} ( {w}_{i} \times {Res}_{i} ) \qquad ( 1 )$$

where I_{final} is an artifact-reduced image of the relevant stage (e.g., partially cleaned image 610), Iᵢₙₚᵤₜ is the input image into the relevant stage, and wᵢ is the preferred weight of the ith predicated artifact, Resᵢ.

For example, the trained artifact estimation network may estimate two artifacts, noise and ringing in a first stage, and may estimate streaking artifacts in a second stage. That is, a first artifact image may be generated at a first output layer of the first stage that may be subtracted from the input image to reduce noise artifacts, and a second artifact image may be generated at a second output layer of the first stage that may be subtracted from the input image to reduce ringing artifacts. The user may prefer to remove all the ringing and streaking artifacts, while only removing 75% of the noise. To accomplish this, a first tuning parameter of 0.75 may be multiplied by each pixel intensity value of the first artifact image (noise) generated at the first output layer of the first stage. A second tuning parameter of 1.0 may be multiplied by each pixel intensity value of the second artifact image (ringing) generated at the second output layer of the first stage. A third tuning parameter of 1.0 may be multiplied by each pixel intensity value of a third artifact image (streaking) generated at an output layer of the second stage. The first artifact image, the second artifact image and the third artifact image may be outputted by the trained artifact estimation network, which may then be both subtracted from the input image (module 336) to generate an artifact-reduced image (e.g., artifact-reduced image 338), in which 25% of the noise is left in artifact-reduced image and the ringing and streaking artifacts are removed. The first and second artifact images may be fully subtracted from the input image to generate a partially cleaned image (e.g., partially cleaned image 610), in which 100% of the noise and 100% of ringing may be removed. The partially cleaned image may then be propagated to the second stage.

It should be appreciated that the weighting of the artifact images and the creation of the partially cleaned image may be independent processes. That is, the artifact images may be subtracted from the input image to generate the partially cleaned image to be propagated to a next stage. The artifact images may be outputted by the network, and separately weighted, to be subtracted from the input image along with the artifact images generated at subsequent stages of the network.

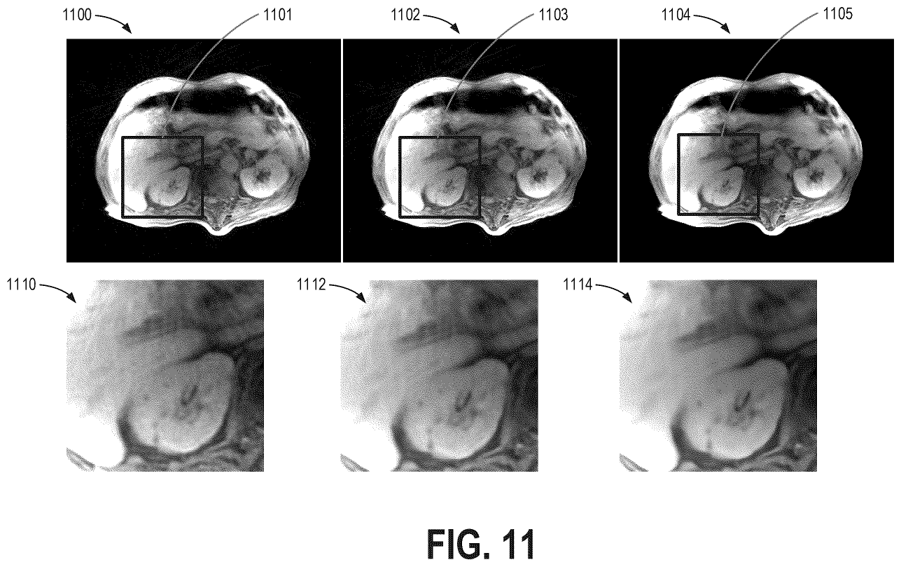

Referring briefly to FIG. 11, examples of a partially cleaned image and an artifact-reduced image generated as described above are shown. An example input image 1100 may be inputted into the trained artifact estimation network. A partially cleaned image 1102 may be generated by removing the artifacts predicated at a first stage of the trained artifact estimation network, and an artifact-reduced image 1104 may be generated by further removing the artifacts estimated at a second stage of the trained artifact estimation network, as described above. Input image 1100 shows various artifacts, including noise, ringing artifacts, and streaking artifacts. The various artifacts are particularly visible in a region 1101 of input MR image 1100. An expanded view of region 1101 is shown below input MR image 1110. As described above, the first stage may estimate and reduce noise and ringing in input MR image 1110. As a consequence, partially cleaned image 1102 may include streaking artifacts, as seen in an expanded view 1112 of a corresponding region 1103 of partially cleaned image 1102. The second stage may estimate and reduce the streaking artifacts in input MR image 1110. As a consequence, artifact-reduced image 1104 may not include the noise, the ringing and the streaking artifacts, as seen in an expanded view 1114 of a corresponding region 1105 of artifact-reduced image 1104.

At 508, method 500 includes displaying the artifact-reduced image outputted by the trained noise estimation network on a display screen of the image processing system (e.g., display device 234 of FIG. 2). The artifact-reduced image may be displayed on the display screen in real time during an examination of the subject, such that an operator of the image processing system (e.g., a caregiver) may review the artifact-reduced image during the examination. The artifact-reduced image may also be outputted to a storage device or a picture archiving and communication system (PACS) for subsequent retrieval and/or remote review. For example, the artifact-reduced image may be used to diagnose a condition of the subject. By reducing the amount of artifact in the acquired MR image, anatomical features of the subject may be more clearly visible to the caregiver, whereby the condition may be more easily diagnosed.

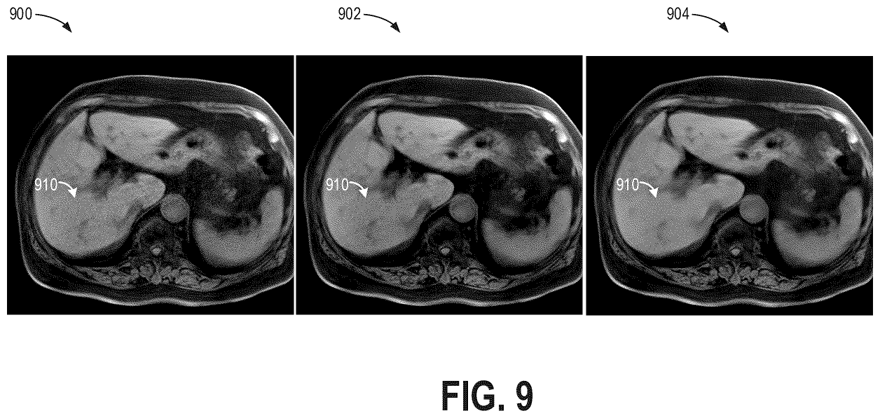

FIG. 9 shows an example artifact-reduced MR image 904 generated using a trained artifact estimation network, such as artifact estimation network 302 of FIG. 3 and/or residual neural network 600 of FIGS. 6-8, in comparison to an input MR image 900 used to generate the artifact-reduced MR image 904, and a second exemplary artifact-reduced MR image 902 generated using a conventional (e.g., non-concatenated) residual neural network not having the architecture described above in reference to FIGS. 6-8. Artifact-reduced MR image 904 shows less artifacts than input MR image 900. For example, streaking artifacts can be seen in a portion 910 of input MR image 900. In artifact-reduced MR image 904, the streaking artifacts have been largely eliminated in the portion 910. Additionally, while the streaking artifacts are reduced in second exemplary artifact-reduced MR image 902, the streaking artifacts are more visible in second exemplary artifact-reduced MR image 902 than in artifact-reduced MR image 904. Thus, by using a CNN having the architecture described in FIGS. 6-8, as opposed to a conventional residual neural network architecture, a greater amount of artifacts may be removed.

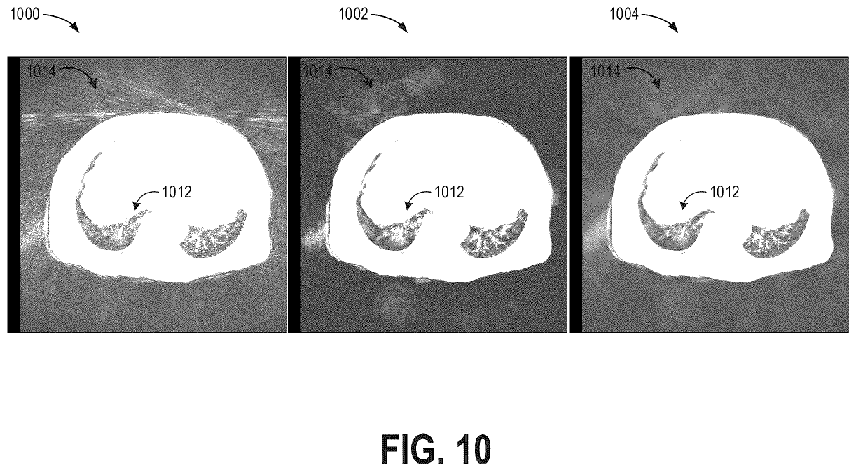

A second example is shown in FIG. 10, which shows an artifact-reduced MR image 1004 generated using the trained artifact estimation network, in comparison to an input MR image 1000 used to generate the artifact-reduced MR image 1004, and a second exemplary artifact-reduced MR image 1002 generated using a conventional (e.g., non-concatenated) residual neural network not having the architecture described above in reference to FIGS. 6-8. Artifact-reduced MR image 1004 shows a reduced number of both streaking artifacts and noise than input MR image 1000. For example, streaking artifacts can be seen in a portion 1014 of input MR image 1000. In artifact-reduced MR image 1004, the streaking artifacts have been substantially reduced in the portion 1014. While the streaking artifacts are reduced in second exemplary artifact-reduced MR image 1002, the streaking artifacts are more visible in second exemplary artifact-reduced MR image 1002 than in artifact-reduced MR image 1004. Additionally, a first amount of noise can be seen in a portion 1012 of input MR image 1000. A second, lesser amount of noise can be seen in the portion 1012 of artifact-reduced MR image 1004, where the noise has been reduced by the trained artifact estimation network. Second exemplary artifact-reduced MR image 1002 shows a third amount of noise at portion 1012, where the third amount of noise is less than the first amount of noise of input MR image 100, but greater than the second amount of noise of artifact-reduced MR image 1004 generated by the conventional (e.g., non-concatenated) residual neural network.

Thus, system and methods are herein described for increasing a performance of an artifact-reducing neural network at reducing artifacts of various types in a medical image. The disclosed artifact-reducing residual network has a multi-stage architecture comprising a plurality of residual blocks that are organized into distinct stages that are concatenated, where each residual block may include a plurality of convolutional layers. The residual blocks and convolutional layers of each stage are configured and trained to detect and reduce different types of artifacts occurring at different scales in the medical image. Artifacts of a local scale may be removed first, by initial stages of the artifact-reducing neural network. Artifacts of a global scale may be removed by later stages of the artifact-reducing neural network. During training, a calculated loss between an artifact-reduced image outputted by the artifact-reducing neural network and a target image is backpropagated through each of the stages of the multi-stage architecture. By training the artifact-reducing neural network in this manner, artifacts occurring at lower scales are successively removed, leaving images with higher quality artifact data of artifacts at higher scales, which allows the artifact-reducing neural network to more effectively learn to detect the artifacts occurring at the higher scales. As a result, artifacts of different types may be more effectively removed from medical images than by using conventional residual networks, including when a plurality of conventional residual networks are chained or trained in parallel. Additionally, the disclosed artifact-reducing neural network may be trained on a single dataset including a wider range of images with varying degrees of noise, wider ranges of signal-to-noise ratios (SNR), and more types of artifacts than alternative artifact-reducing neural networks not having the disclosed architecture and training. The technical effect of training and using the disclosed artifact-reducing neural network to reduce artifacts in medical images is that a quality of the medical images may be increased, resulting in more accurate diagnoses and more effective patient treatment.

The disclosure also provides support for an image processing system comprising: a trained artifact estimation network including a plurality of stages, the artifact estimation network trained to estimate artifacts in a medical image, and a processor communicably coupled to a non-transitory memory storing the artifact estimation network, the memory including instructions that when executed, cause the processor to: receive a medical image, generate an estimated artifact image from the medical image using the trained artifact estimation network, generate an artifact-reduced image by subtracting the estimated artifact image from the medical image, the artifact-reduced image a version of the medical image including a lesser amount of artifacts than the medical image, and display the artifact-reduced image on a display device, wherein each stage of the trained artifact estimation network estimates artifacts of a different scale in the medical image. In a first example of the system, each stage the artifact estimation network includes a first plurality of convolutional layers organized into a second plurality of residual blocks, and residual connections are used to bypass one or more convolutional layers within the stage. In a second example of the system, optionally including the first example: the artifact estimation network includes at least a first stage and a second stage, each of the first stage and the second stage including an input layer, a plurality of convolutional layers, and a stage output layer, the first stage estimates and reduces local artifact data from the medical image, and the second stage estimates and reduces global artifact data from the medical image. In a third example of the system, optionally including one or both of the first and second examples, the local artifact data includes noise and ringing artifacts, and the global artifact data includes streaking artifacts and motion artifacts. In a fourth example of the system, optionally including one or more or each of the first through third examples, further instructions are stored in the memory that when executed, cause the processor to: during generation of the artifact-reduced medical image from the medical image using the trained artifact estimation network: combine feature maps of each output node of the first stage to create a first stage-specific artifact image, the first stage-specific artifact image including local artifact data of the medical image, and not including image data of anatomical features of the medical image, and subtract the first stage-specific artifact image from the medical image to generate a partially cleaned image, the partially cleaned image a version of the medical image where local artifacts have been reduced. In a fifth example of the system, optionally including one or more or each of the first through fourth examples, further instructions are stored in the memory that when executed, cause the processor to: input the partially cleaned image into the input layer of the second stage, combine feature maps of each output node of the second stage to create a second stage-specific artifact image, the second stage-specific artifact image including global artifact data of the medical image, and not including image data of the anatomical features of the medical image or the local artifact data, and subtract the second stage-specific artifact image from the partially cleaned image to generate the artifact-reduced image. In a sixth example of the system, optionally including one or more or each of the first through fifth examples, nodes of the plurality of convolutional layers of the second stage are configured to have a larger reception field than nodes of the plurality of convolutional layers of the first stage. In a seventh example of the system, optionally including one or more or each of the first through sixth examples, further instructions are stored in the memory that when executed, cause the processor to: during training of the artifact estimation network: input a noisy medical image into the artifact estimation network, the noisy medical image a combination of a high-quality medical image and one or more artifact images, backpropagate a loss between an artifact image outputted by the artifact estimation network and the one or more synthesized artifact images, and adjust parameters of both of the first stage and the second stage of the artifact estimation network based on the backpropagated loss. In a eighth example of the system, optionally including one or more or each of the first through seventh examples, the second stage-specific artifact image is an output of the artifact estimation network, the second stage-specific artifact image comprising a first set of 2D matrices of pixel intensity values, each value of the first set of 2D matrices corresponding to a pixel of the medical image. In a ninth example of the system, optionally including one or more or each of the first through eighth examples, first stage-specific artifact image is an additional output of the artifact estimation network, the first stage-specific artifact image comprising a second set of 2D matrices of values, each value of the second 2D matrices corresponding to a pixel of the medical image, and wherein the artifact-reduced image is generated by subtracting the first and second sets of 2D matrices of values from the medical image. In a tenth example of the system, optionally including one or more or each of the first through ninth examples, further instructions are stored in the memory that when executed, cause the processor to: receive relative weight values for different types of artifacts of the medical image from a user of the image processing system, and apply the relative weight values to at least one of the first stage-specific artifact image and the second stage-specific artifact image to preferentially adjust the amount of the different types of artifacts to be reduced from the medical image. In a eleventh example of the system, optionally including one or more or each of the first through tenth examples, the relative weight values are received via an artifact weighting scheme submitted to the image processing system by the user via a selection from a menu displayed on the display device. In a twelfth example of the system, optionally including one or more or each of the first through eleventh examples, the one or more artifact images are synthesized artifact images. In a thirteenth example of the system, optionally including one or more or each of the first through twelfth examples, the artifact-reduced image is displayed on the display device in real time during an examination of a subject of the medical image.

The disclosure also provides support for a method for training a residual neural network to reduce an amount of artifacts in a medical image, the method comprising: receiving a set of training image pairs, each training image pair including a plurality of ground truth, target artifact images, and a noisy medical image comprising a high-quality medical image combined with the plurality of ground truth, target artifact images as an input image, inputting an input image of a training image pair of the set of training image pairs into a first stage of the residual neural network, estimating, at the first stage of the residual neural network, a first set of local artifact images of the plurality of ground truth, target artifact images, subtracting the first set of estimated local artifact images from the noisy medical image to generate a partially cleaned image, the partially cleaned image including a reduced amount of artifacts of a local scale, inputting the partially cleaned image into a second stage of the residual neural network, estimating, at the second stage of the residual neural network, a second set of global artifact images of the plurality of ground truth, target artifact images, combining the first set of estimated local artifact images with the second set of estimated global artifact images, to create a combined artifact image, subtracting the second set of estimated global artifact images from the partially cleaned image to generate an artifact-reduced image, the artifact-reduced image including a reduced amount of artifacts of both a local scale and a global scale, backpropagating a loss between the combined artifact image and the plurality of ground truth, target artifact images of the training image pair through a second plurality of convolutional layers of the second stage and a first plurality of convolutional layers of the first stage, and adjusting both of a first set of parameters at a first plurality of nodes of the first plurality of convolutional layers and a second set of parameters at a second plurality of nodes of the second plurality of convolutional layers based on the backpropagated loss. In a first example of the method, inputting the input image into the first stage of the residual neural network to estimate the first set of local artifact images and generate the partially cleaned image further comprises: propagating image data of the input image through the first plurality of convolutional layers of the first stage, to generate a first plurality of feature maps at a respective first plurality of output nodes of the first stage, each feature map of the first plurality of feature maps including artifact data of a different type of local artifact, generating the first set of artifact images based on the first plurality of feature maps. In a second example of the method, optionally including the first example, inputting the partially cleaned image into the second stage of the residual neural network to estimate the second set of global artifact images further comprises: propagating image data of the partially cleaned image through the second plurality of convolutional layers of the second stage, to generate a second plurality of feature maps at a respective second plurality of output nodes of the second stage, each feature map of the second plurality of feature maps including artifact data of a different type of global artifact, generating the second set of global artifact images based on the second plurality of feature maps. In a third example of the method, optionally including one or both of the first and second examples, nodes of convolutional layers of the second stage are configured to have a larger reception field than nodes of convolutional layers of the first stage. In a fourth example of the method, optionally including one or more or each of the first through third examples, the first set of local artifact images include at least one of noise and ringing artifacts, and the second set of global artifact images include at least one of streaking artifacts and motion artifacts.

The disclosure also provides support for a residual neural network trained to reduce an amount of artifacts in a medical image, the residual neural network comprising a plurality of stages, the plurality of stages including at least: a first stage that takes as input the medical image and generates a first version of the medical image having a reduced number of artifacts of a first scale, and a second stage that takes as input the first version of the medical image, and generates a second version of the medical image having a reduced number of artifacts of both of the first scale and a second scale.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object. In addition, it should be understood that references to “one embodiment” or “an embodiment” of the present disclosure are not intended to be interpreted as excluding the existence of additional embodiments that also incorporate the recited features.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. An image processing system comprising:
a trained artifact estimation network including a plurality of stages, the artifact estimation network trained to estimate artifacts in a medical image; and
a processor communicably coupled to a non-transitory memory storing the artifact estimation network, the memory including instructions that when executed, cause the processor to:
receive a medical image;
generate an estimated artifact image from the medical image using the trained artifact estimation network;
generate an artifact-reduced image by subtracting the estimated artifact image from the medical image, the artifact-reduced image a version of the medical image including a lesser amount of artifacts than the medical image; and
display the artifact-reduced image on a display device;
wherein each stage of the trained artifact estimation network estimates artifacts of a different scale in the medical image.

2. The image processing system of claim 1, wherein each stage the artifact estimation network includes a first plurality of convolutional layers organized into a second plurality of residual blocks, and residual connections are used to bypass one or more convolutional layers within the stage.

3. The image processing system of claim 1, wherein:
the artifact estimation network includes at least a first stage and a second stage, each of the first stage and the second stage including an input layer, a plurality of convolutional layers, and a stage output layer;
the first stage estimates and reduces local artifact data from the medical image; and
the second stage estimates and reduces global artifact data from the medical image.

4. The image processing system of claim 3, wherein the local artifact data includes noise and ringing artifacts, and the global artifact data includes streaking artifacts and motion artifacts.

5. The image processing system of claim 3, wherein further instructions are stored in the memory that when executed, cause the processor to:
during generation of the artifact-reduced image from the medical image using the trained artifact estimation network:
combine feature maps of each output node of the first stage to create a first stage-specific artifact image, the first stage-specific artifact image including local artifact data of the medical image, and not including image data of anatomical features of the medical image; and
subtract the first stage-specific artifact image from the medical image to generate a partially cleaned image, the partially cleaned image a version of the medical image where local artifacts have been reduced.

6. The image processing system of claim 5, wherein further instructions are stored in the memory that when executed, cause the processor to:
input the partially cleaned image into the input layer of the second stage;
combine feature maps of each output node of the second stage to create a second stage-specific artifact image, the second stage-specific artifact image including global artifact data of the medical image, and not including image data of the anatomical features of the medical image or the local artifact data; and
subtract the second stage-specific artifact image from the partially cleaned image to generate the artifact-reduced image.

7. The image processing system of claim 3, wherein nodes of the plurality of convolutional layers of the second stage are configured to have a larger reception field than nodes of the plurality of convolutional layers of the first stage.

8. The image processing system of claim 3, wherein further instructions are stored in the memory that when executed, cause the processor to:
during training of the artifact estimation network:
input a noisy medical image into the artifact estimation network, the noisy medical image a combination of a high-quality medical image and one or more artifact images;
backpropagate a loss between an artifact image outputted by the artifact estimation network and the one or more synthesized artifact images; and
adjust parameters of both of the first stage and the second stage of the artifact estimation network based on the backpropagated loss.

9. The image processing system of claim 6, wherein the second stage-specific artifact image is an output of the artifact estimation network, the second stage-specific artifact image comprising a first set of 2D matrices of pixel intensity values, each value of the first set of 2D matrices corresponding to a pixel of the medical image.

10. The image processing system of claim 9, wherein first stage-specific artifact image is an additional output of the artifact estimation network, the first stage-specific artifact image comprising a second set of 2D matrices of values, each value of the second 2D matrices corresponding to a pixel of the medical image, and wherein the artifact-reduced image is generated by subtracting the first and second sets of 2D matrices of values from the medical image.

11. The image processing system of claim 10, wherein further instructions are stored in the memory that when executed, cause the processor to:
receive relative weight values for different types of artifacts of the medical image from a user of the image processing system; and
apply the relative weight values to at least one of the first stage-specific artifact image and the second stage-specific artifact image to preferentially adjust the amount of the different types of artifacts to be reduced from the medical image.

12. The image processing system of claim 11, wherein the relative weight values are received via an artifact weighting scheme submitted to the image processing system by the user via a selection from a menu displayed on the display device.

13. The image processing system of claim 8, wherein the one or more artifact images are synthesized artifact images.

14. The image processing system of claim 1, wherein the artifact-reduced image is displayed on the display device in real time during an examination of a subject of the medical image.

15. A method for training a residual neural network to reduce an amount of artifacts in a medical image, the method comprising:
receiving a set of training image pairs, each training image pair including a plurality of ground truth, target artifact images, and a noisy medical image comprising a high-quality medical image combined with the plurality of ground truth, target artifact images as an input image;
inputting an input image of a training image pair of the set of training image pairs into a first stage of the residual neural network;
estimating, at the first stage of the residual neural network, a first set of local artifact images of the plurality of ground truth, target artifact images;
subtracting the first set of estimated local artifact images from the noisy medical image to generate a partially cleaned image, the partially cleaned image including a reduced amount of artifacts of a local scale;
inputting the partially cleaned image into a second stage of the residual neural network;
estimating, at the second stage of the residual neural network, a second set of global artifact images of the plurality of ground truth, target artifact images;
combining the first set of estimated local artifact images with the second set of estimated global artifact images, to create a combined artifact image;
subtracting the second set of estimated global artifact images from the partially cleaned image to generate an artifact-reduced image, the artifact-reduced image including a reduced amount of artifacts of both a local scale and a global scale;
backpropagating a loss between the combined artifact image and the plurality of ground truth, target artifact images of the training image pair through a second plurality of convolutional layers of the second stage and a first plurality of convolutional layers of the first stage; and
adjusting both of a first set of parameters at a first plurality of nodes of the first plurality of convolutional layers and a second set of parameters at a second plurality of nodes of the second plurality of convolutional layers based on the backpropagated loss.

16. The method of claim 15, wherein inputting the input image into the first stage of the residual neural network to estimate the first set of local artifact images and generate the partially cleaned image further comprises:
propagating image data of the input image through the first plurality of convolutional layers of the first stage, to generate a first plurality of feature maps at a respective first plurality of output nodes of the first stage, each feature map of the first plurality of feature maps including artifact data of a different type of local artifact;
generating the first set of artifact images based on the first plurality of feature maps.

17. The method of claim 15, wherein inputting the partially cleaned image into the second stage of the residual neural network to estimate the second set of global artifact images further comprises:
propagating image data of the partially cleaned image through the second plurality of convolutional layers of the second stage, to generate a second plurality of feature maps at a respective second plurality of output nodes of the second stage, each feature map of the second plurality of feature maps including artifact data of a different type of global artifact;
generating the second set of global artifact images based on the second plurality of feature maps.

18. The method of claim 15, wherein nodes of convolutional layers of the second stage are configured to have a larger reception field than nodes of convolutional layers of the first stage.

19. The method of claim 15, wherein the first set of local artifact images include at least one of noise and ringing artifacts, and the second set of global artifact images include at least one of streaking artifacts and motion artifacts.

20. A residual neural network trained to reduce an amount of artifacts in a medical image, the residual neural network comprising a plurality of stages, the plurality of stages including at least:
a first stage that takes as input the medical image and generates a first version of the medical image having a reduced number of artifacts of a first scale; and
a second stage that takes as input the first version of the medical image, and generates a second version of the medical image having a reduced number of artifacts of both of the first scale and a second scale.
